(19) United States
(12) Patent Application Publication
(10) Pub. No.: US 2026/0228741 A1
(43) Pub. Date: Aug. 6, 2026

(54) METHOD AND SYSTEM FOR DETERMINING OUTCOME FOR ELECTRONIC TRANSACTION

(71) Applicant: ACCENTURE GLOBAL SOLUTIONS LIMITED, Dublin 4 (IE)

(72) Inventors: Shubhashis SENGUPTA, Bangalore (IN); Roshni Ramesh RAMNANI, Bangalore (IN); Anutosh MAITRA, Bangalore (IN); Sukanti BEER, Bangalore (IN); Mansi SRIVASTAVA, Lucknow (IN)

(73) Assignee: ACCENTURE GLOBAL SOLUTIONS LIMITED, Dublin 4 (IE)

(21) Appl. No.: 19/046,141

(22) Filed: Feb. 5, 2025

(51) Int. Cl. G06Q 20/40; G06Q 30/0207; G06Q 30/0601; H04L 67/306

(52) U.S. Cl. CPC G06Q 20/405; G06Q 30/0207; G06Q 30/0631; H04L 67/306

(57) ABSTRACT

Method, system and computer-readable medium are disclosed for determining an outcome for an electronic transaction over a computer network. An initial proposition is communicated to a user via an initial proposition communication to facilitate the electronic transaction. Additional information associated with the electronic transaction and the initial proposition is gathered by interacting with the user, via a virtual agent. Based on the gathered additional information, the initial proposition is dynamically modified to generate an alternative proposition. The alternative proposition includes generating an alternative engagement strategy based on adjusting of weighting values of a strategy selection model configured to evaluate multiple engagement strategies. The alternative proposition is communicated to the user via an alternative proposition communication. Further, a response to the alternative proposition from the user is received. Based on the response to the alternative proposition, the outcome for the electronic transaction is determined.

### TECHNICAL FIELD

Various embodiments described herein relate generally to method, system, and non-transitory computer readable medium for determining an outcome for an electronic transaction.

### BACKGROUND

Enterprises deploy online systems to provision products and/or services to users. To assist interactions of the users with the online systems for the products and/or the services, the online systems may deploy various online tools. An example online tool includes virtual agents, commonly referred to as chatbots. In general, a virtual agent may be described as an online virtual assistant that interacts with a user to provide information about the products and/or the services and/or to execute actions specified by the user. Also, the virtual agent may be used as a tool for several other purposes including, for example, an enquiry service, marketing, educational purposes, routing requests, and/or the like. Therefore, the virtual agent may be used in a range of domains such as, for example, electronic commerce (e-commerce), education, entertainment, finance, health, news, and productivity.

An existing online system may enable the virtual agent to operate based on predefined rules, templates, and predefined knowledge base. The predefined rules may determine a scope of a query that may be addressed by the virtual agent and a depth of a response that is provided by the virtual agent. However, the virtual agent operating based on the predefined rules, the templates and the predefined knowledge base may not be able to capture diversity, complexity of needs, context, intent, and emotions of the user, and/or the like. Therefore, the virtual agent deployed by the existing online system may fail to provide personalized, interactive, and creative experiences that may engage the user with the existing online system.

Further, the virtual agent operating based on the predefined rules, the templates and the predefined knowledge base may have difficulty in handling natural language queries, complex requests, and/or ambiguous inputs from the user and may lack the ability to adapt to feedback and changes in the context, the intent, and the emotions of the user. The rules may be often generalized, so that the virtual agent may lose contextuality associated with the individual user and may contradict a purpose of a current conversation. For example, if an input received from the user includes “I wish to gift my wife a necklace during this festival”, the virtual agent may interpret “festival” only for “expensive gift”, unless the context is determined. Therefore, the virtual agent deployed by the exiting online system may have limitations such as, for example, limited comprehension of the query received from the user, presenting the same response for the query repeatedly (during different loops/iterations), and/or providing an irrelevant response. Such limitations may turn out the interaction between the user and the existing online system may inefficient, without deriving any outcome and limit the user to interact with the existing online system in a take it or leave it approach.

For example, consider a scenario where the user initiates an interaction with the existing online system, via the virtual agent, for assistance in purchasing “a phone of a brand A with 16 Mega Pixels (MP) primary camera and a large display”. Accordingly, the virtual agent may provide a response as “a phone X that matches your camera and display requirements”. Thereafter, the user queries for “memory specification of the phone X” and receives, from the virtual agent, a response as “the phone X contains 2 Giga Byte (GB) RAM”. Upon receiving the response, the user may provide a response as “require at least 4 GB RAM”. However, the virtual agent deployed by the existing online system may fail to identify a change in such context and intent of the user and fail to provide any alternative suggestion or recommendation to the user. Therefore, the interaction between the user and the existing online system may end up without deriving any outcome. In addition, from a user experience perspective, the virtual agent may lack capability to provide engaging and customized interactions with the user that can mimic human-like interactions, as well as the ability to use humor, empathy, and creativity to build rapport and trust with the user. In some examples, if the virtual agent fails to provide any alternative suggestion or recommendation to the user, the virtual agent may involve a human agent to connect with the user for tasks, for example, nudging the user or upselling or negotiation. Therefore, the existing online system may expend a significant amount of time and human resources in order to facilitate the interactions with the user.

In some examples, the enterprises may leverage Generative Artificial Intelligence (GAI) to address the limitations or drawbacks of the virtual agent. However, such a GAI integrated virtual agent may operate efficiently only for user-oriented tasks such as, writing emails, conceptual understanding, generating images, and/or the like.

Therefore, in the existing online system, the virtual agent may have challenges including maintaining the context and the intent of the user in the interactions, providing consistent and tailored responses, and managing consumption of technical resources (e.g., processing, memory, bandwidth) as well as human agents. Additional challenges that arise include maintaining user trust as well as handling updates from the user.

### SUMMARY

In an aspect, the present disclosure relates to a method for determining an outcome for an electronic transaction over a computer network. The method includes gathering information associated with the electronic transaction, including information associated with one or more of a product, service, or entity associated with the electronic transaction. The method includes generating a user profile for a user associated with the electronic transaction. Based on the information associated with the electronic transaction and the user profile, the method includes modifying an aspect of a virtual agent configured to facilitate the electronic transaction. The method includes communicating an initial proposition to the user via an initial proposition communication. The initial proposition is based on initial engagement strategy to facilitate the electronic transaction. The method includes interacting, via the virtual agent, with the user to gather additional information associated with the electronic transaction and the initial proposition. The method includes dynamically modifying the initial proposition to generate an alternative proposition. The alternative proposition includes generating an alternative engagement strategy to facilitate the electronic transaction based on the initial engagement strategy and the additional information. The alternative engagement strategy is generated based on adjusting of weighting values of a strategy selection model configured to evaluate a plurality of engagement strategies. The method includes communicating the alternative proposition to the user via an alternative proposition communication. The method includes receiving a response to the alternative proposition from the user. Based on the response to the alternative proposition, the method includes determining the outcome for the electronic transaction.

In some examples, the method further includes analyzing the response to the alternative proposition from the user to generate a future proposition and implementing the future proposition in a future electronic transaction associated with the user or another user.

In some examples, generating the user profile includes gathering information associated with one or more previous electronic transactions, demographic information, emotional state information, constraint information, and intent information.

In some examples, the alternative engagement strategy based on consultation includes one or more of a persuasive insight associated with the alternative proposition, a persuasive insight associated with the user, and a fact supporting the alternative proposition.

In some examples, the alternative engagement strategy is based on one or more of a credibility appeal, a logical appeal, and an emotional appeal.

In some examples, the additional information includes one or more of nonverbal cues, situation information, and emotional state information associated with the user.

In some examples, the alternative proposition includes one or more of targeted advice associated with the electronic transaction, a counteroffer, a discounted price, an alternative service, an alternative product, an additional service, an additional product, and a modified service, or a modified product.

In some examples, the alternative proposition includes one or more of a persuasion, a nudge, a negotiation, and advice associated with the electronic transaction.

In some examples, generating the initial proposition communication includes providing the initial engagement strategy to a Large Language Model (LLM) to generate initial proposition communication.

In some examples, generating the alternative proposition communication includes providing the alternative engagement strategy to the LLM to generate the alternative proposition communication.

In another aspect, the present disclosure relates to a system for implementing the method provided herein. In another aspect, the present disclosure relates to a non-transitory computer-readable medium including machine-executable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 depicts an example environment used to execute implementations of the present disclosure.

FIG. 2 depicts an exemplary architecture of a transaction manager of a system for facilitating and determining an outcome for an electronic transaction, in accordance with implementations of the present disclosure.

FIG. 3 depicts an exemplary process flow of generating dataset and training an intent model based on the generated dataset, in accordance with implementations of the present disclosure.

FIG. 4 depicts an exemplary illustration of facilitating the electronic transaction between a user device/user and the system, while deriving the outcome for the electronic transaction, in accordance with implementations of the present disclosure.

FIG. 5 depicts an exemplary illustration of generating the alternative proposition including advice or suggestions, in accordance with implementations of the present disclosure.

FIG. 6 depicts an exemplary flow diagram that presents a method for determining the outcome for the electronic transaction over the computer network, in accordance with implementations of the present disclosure.

FIG. 7 depicts an example computer system, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” and/or the like, are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the disclosure as set forth in the claims.

This disclosure should be interpreted according to the exemplary definitions provided below. In case of a contradiction between the definitions in the definitions section and other sections of this disclosure, this section should prevail. In case of a contradiction between the definitions in this section and a definition or a description in any other document, including in another document incorporated in this disclosure by reference, this section should prevail, even if the definition or the description in the other document is commonly accepted by a person of ordinary skill in the art.

“Electronic transaction” and/or the like may refer to interactions or conversations between a user device/user and an online system over a computer network for information associated with one or more of: a product, a service, and an entity.

“Input” and/or the like may refer to a request received from the user for information associated with one or more of: a product, a service, and an entity.

“Virtual agent” and/or the like may refer to an online assistant tool used to facilitate the electronic transaction between the user device/user and the online system over the computer network.

“Initial proposition” and/or the like may include one or more initial propositions generated based on the input. Each of the one or more initial propositions may include information requested by the user or supplemental information.

“Additional information” and/or the like may include one or more dialogs/responses received from the user for the one or more initial propositions.

“Alternative proposition” and/or the like may include one or more alternative propositions. Each of the one or more alternative propositions may refer to a proposition that persuades or nudges, or advice the user or provides negotiations to the user to continue engaging with the electronic transaction.

“Response” and/or the like may include one or more dialogs/responses received from the user for the one or more alternative propositions.

“Outcome” and/or the like may indicate a result associated with the electronic transaction. The outcome may indicate a successful transaction or a failure transaction. The outcome may indicate a capability of the virtual agent to determine an answer that may be acceptable by the user, thereby driving the user towards a positive outcome. The outcome may also indicate a soft goal such as user engagement with the electronic transaction, upselling products and/or services, and/or the like.

Implementations of the present disclosure are directed to a conversational commerce optimization system that optimizes a virtual agent leveraging a Large Language Model (LLM) to determine an outcome for an electronic transaction between a user and an online system, while providing an initial proposition and an alternative proposition to the user. The alternative proposition may be provided by evaluating and selecting one of multiple engagement strategies, based on the user profile, additional information associated with the electronic transaction and the initial proposition. The selected engagement strategy based on consultation may include one or more of a persuasive insight associated with the alternative proposition, a persuasive insight associated with the user, and a fact supporting the alternative proposition. The alternative proposition may include one or more of: a nudge, a negotiation, and advice associated with the electronic transaction. Therefore, personalized, interactive, and creative electronic transaction may be facilitated between the user and online system, while enabling conversion of the electronic transaction to reach the outcome or goal.

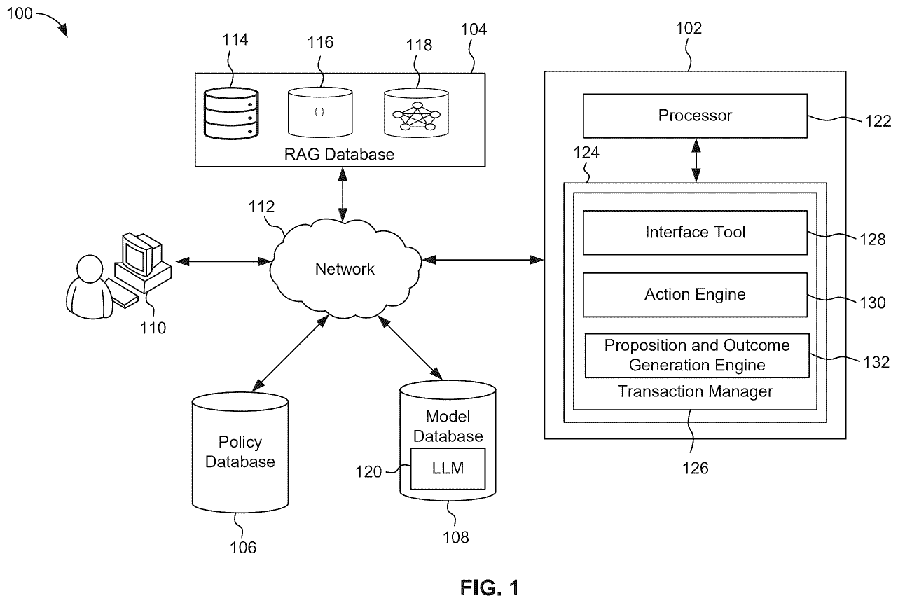

FIG. 1 depicts an example environment 100 that may be used to execute implementations of the present disclosure. The example environment 100, depicted in FIG. 1, includes a system 102, a Retrieval-Augmented Generation (RAG) database 104, a policy database 106, a model database 108, and a user device 110. For simplicity, the example environment 100 including the system 102, and the user device 110 is depicted in FIG. 1, however it should be noted that the example environment 100 may include one or more systems and one or more user devices. The system 102 may be communicatively coupled with the RAG database 104, the policy database 106, the model database 108, and the user device 110 over a network 112 (also be referred to as computer network). In some examples, the network 112 may include, but is not limited to, a Local Area Network (LAN), a Wide Area Network (WAN), the Internet, or a combination thereof. In some other examples, the network 112 may be accessed over a wired and/or a wireless communication link.

In some examples, the RAG database 104 includes a relational database 114, a vector database 116, and a graph database 118 (also be referred to as knowledge database) for storing information. In some examples, the graph database 118 may be fine-tuned or updated during an offline process. The information stored in the RAG database 104 may be related to one or more of: products, services, and entities of various domains. Examples of the domains may include, but are not limited to, retail industries (including enterprise applications), healthcare, educational domain, industrial equipment, software development, and/or the like. The information related to the products may include product data such as, but are not limited to, categories, features, prices, ratings, and/or the like of the products. By way of non-limiting example, a product may include a smartphone and product data related to the smartphone may indicate features such as a color, a size, a processor, internal storage, type, and size of a display, a camera quality, a battery life, a price, and/or the like. The information related to the services may include information related to one or more of educational services, medical services, entertainment, marketing services, tourist services, event related services, gaming services, and/or the like. By way of non-limiting example, the information related to the educational services may indicate training or learning being provided by different educational instructions on various subjects or courses, fees associated with the training or learning, and/or the like. The entities may include organizations, enterprises, educational institutions, medical service providers, and/or the like, which may provide one or more of the products and/or the services. The information related to the entities may include establishment details of the entities, operation details of the entities, demographic details of the entities, product or service launches of the entities, ratings of the entities, and/or the like. In some examples, the information may be in form of text, images, video, audio, brochures, marketing materials, and/or the like. The relational database 114 may store and organize the information in predefined relationships. The vector database 116 may store the information in vector representation or embeddings. The graph database 118 may use graph structures for semantic queries with nodes, edges, and properties to represent and store the information.

The policy database 106 may include policy information associated with the products, the services, the entities, and/or the like. In some examples, the policy information may include company policies indicating one or more of: special discounts or seasonal promotions applied on the products, discounts, loyalty programs, or special offers being provided by the entities for one or more specific users, security or privacy policies, a maximum discount available on one or more of: the products and the services, and specific users who may avail memberships, reward points, special offers, and/or the like.

The model database 108 may include a Large Language Model (LLM) 120. In the present disclosure, the LLM 120 may also be referred to as a foundation model, a GAI model, and/or the like. Also, for simplicity, the model database 108 including the LLM 120 is depicted in FIG. 1, however it should be noted that the model database 108 may include one or more LLMs. The LLM 120 may be a general-purpose Generative Artificial Intelligence (GAI) model like a large deep learning neural network, which may be trained using a broad range of generalized and unlabeled training data to perform the one or more tasks such as, human computer interactions (e.g., question and answering), automating process execution, process planning, generating step-by-step procedures for the process execution, performing data analysis, and/or the like. In accordance with implementations of the present disclosure, the LLM 120 may be trained on training datasets to learn a dialog act to system action mapping and dialog generation. While implementations of the present disclosure are described in further detail herein with non-limiting reference to the LLM 120, it is contemplated that implementations of the present disclosure may be realized using any appropriate foundation models or Machine Learning (ML) models, or Artificial Intelligence (AI) models.

The user device 110 may be associated with a user (e.g., a customer, a buyer, a client, and/or the like). The user device 110 may include computing devices such as desktop computing devices, smartphones, laptops, tablet, voice-enabled devices, and/or the like. It is contemplated that implementations of the present disclosure may be realized with any appropriate type of computing device. The user device 110 may enable the user to log into and interact with computing platforms being hosted by the system 102 to execute applications on the user device 110. In some examples, the computing platforms may include, but are not limited to, an e-commerce platform, a web platform, an educational platform, a content delivery platform, and/or the like. In the present disclosure, the applications being executed by the computing platforms may include virtual agents (also be referred to as chatbots, virtual assistants, and/or the like), which enable the user of the user device 110 to interact or converse with the system 102 for the information related to one or more of a product, a service, or an entity. Thereby, the virtual agents may facilitate electronic transactions between the system 102 and the user device 110/user of the user device 110 over the network 112.

The system 102 (also be referred to as an online system, a transaction system, and/or the like) may be implemented as an on-premises system that is operated by an enterprise or a third-party engaged in cross-platform interactions and data management. In some examples, the system 102 may be implemented as an off-premises system (for example, cloud or on-demand) that is operated by an enterprise or a third-party on behalf of an enterprise. In some examples, the system 102 may be implemented in a cloud environment. For simplicity, the system 102 depicted in FIG. 1 may be a cloud environment that is intended to represent various forms of servers including a web server, an application server, a proxy server, a network server, a server pool, and/or the like.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications.

Still referring to FIG. 1, the system 102 includes a processor 122 and a memory 124 communicably coupled to the processor 122. The processor 122 may include one or more processors. Examples of the processor 122 may include, but are not limited to, microprocessors, microcomputers, microcontrollers, digital signal processors, central processing units, state machines, logic circuits, and/or any devices that manipulate data or signals based on operational instructions. Among other capabilities, the processor 122 may fetch instructions (also be referenced to as processor-executable instructions or machine-executable instructions) from the memory 124 and execute the fetched instructions for performing operations according to the present disclosure. The memory 124 may be non-volatile or non-transitory computer-readable medium (CRM) such as, a magnetic disk or solid-state non-volatile memory or volatile medium such as Random Access Memory (RAM), and/or the like. Further, the system 102 includes a transaction manager 126. The transaction manager 126 may be stored in the memory 124 and provided as a downloadable library including the instructions. The transaction manager 126 includes an interface tool 128, an action engine 130, and a proposition and outcome generation engine 132.

In an example implementation, the processor 122 may execute the interface tool 128 to provide an interface for a virtual agent, which is being executed on the user device 110 of the user to receive an input from the user and facilitate interactions between the user of the user device 110 and system 102, based on the input.

In an example implementation, the processor 122 may execute the action engine 130 to configure the virtual agent to drive the interactions between the user of the user device 110 and the system 102, based on the input received from the user. In some examples, if the input received from the user includes greetings or salutations such as, but are not limited to, “Hi”, “Hello”, “Thank you”, and/or the like, the action engine 130 enable the virtual agent to provide a default response for the input. The default response may include a reply to the greeting or salutations. In some other examples, if the input received from the user is associated with an electronic transaction, the action engine 130 may enable the virtual agent to route such an input to the proposition and outcome generation engine 132. The input associated with the electronic transaction may include a query or a request for information related to one or more of a product, a service, an entity, and/or the like. For example, if the input received from the user includes a query for a smartphone, the action engine 130 may enable the virtual agent to route the query to the proposition and outcome generation engine 132 and receive instructions from the proposition and outcome generation engine 132 to how to facilitate or drive the electronic transaction, which is described in detail along with the proposition and outcome generation engine 132.

In an example implementation, the processor 122 may execute the proposition and outcome generation engine 132 to facilitate, via the virtual agent, the electronic transaction between the user and the system 102, while deriving an outcome for the electronic transaction.

The proposition and outcome generation engine 132 may generate an initial proposition, by gathering information associated with the electronic transaction from the RAG database 104 (including one of: the relational database 114, the vector database 116, and the graph database 118) and identifying a user profile of the user. The proposition and outcome generation engine 132 may use the LLM 120 to generate an initial proposition communication for the initial proposition by processing the gathered information and the identified user profile. The proposition and outcome generation engine 132 may provide the initial proposition communication to the user, via the virtual agent. The proposition and outcome generation engine 132 may receive additional information from the user, via the virtual agent, to the initial proposition communication and accordingly generate an alternative proposition. The alternative proposition may persuade or nudge the user or provide negotiation or advice to the user to engage or continue engaging with the electronic transaction. The alternative proposition may be generated based on evaluation of engagement strategies, the policy information gathered from the policy database 106, the user profile, and/or the like. The proposition and outcome generation engine 132 may use the LLM 120 to generate an alternative proposition communication for the alternative proposition. The proposition and outcome generation engine 132, via the virtual agent, may provide the alternative proposition communication to the user and receive a response from the user to the alternative proposition communication. Based on the response received from the user to the alternative proposition, the proposition and outcome generation engine 132 may determine the outcome for the electronic transaction. The outcome may indicate a successful transaction or a failure transaction.

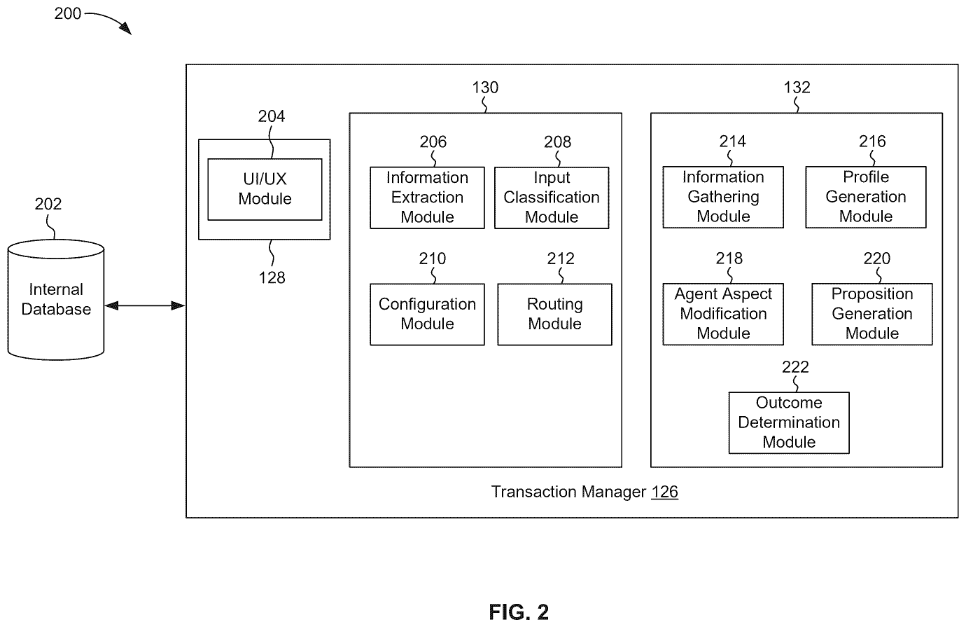

Various examples of determining the outcome for the electronic transaction while providing the alternative proposition are described in detail in conjunction with FIGS. 2-7.

FIG. 2 depicts an exemplary architecture 200 of the transaction manager 126 in the system 102 depicted in FIG. 1, for facilitating and determining the outcome for the electronic transaction, in accordance with implementations of the present disclosure. As depicted in FIG. 2, the transaction manager 126 may be communicatively coupled with an internal database 202. The internal database 202 may store engagement strategies, user profiles of users, previous electronic transactions, and/or the like, which are described in detail below. It should be noted that the user profiles may be generated, managed, and stored in the internal database 202 only based upon receiving explicit consents from the respective users before the user profiles are generated and used. Also, the user profiles of the users may be deleted per regulations and prior consents from the respective users. Therefore, implementations of the present disclosure operate only on the user profiles that the users have consented to, and do not operate on a full brain scan worth of data of the users. Additionally, or alternatively, the internal database 202 may store various data and intermediate results generated by the interface tool 128, the action engine 130, and the proposition and outcome generation engine 132 of the transaction manager 126.

As depicted in FIG. 2, the interface tool 128 includes a User Interface (UI)/User Experience (UX) module 204. The UI/UX module 204 may represent one or more interfaces of the virtual agent that may be executed on the user device 110 (depicted in FIG. 1) to receive an input (also be referred to as dialog) from the user of the user device 110 and accordingly facilitate an interaction between the user of the user device 110 and the system 102 over the network 112 (depicted in FIG. 1). In some examples, the input may be at least in a form of natural language text, an image, a video, and/or the like.

The action engine 130 includes an information extraction module 206, an input classification module 208, a configuration module 210, and a routing module 212, as depicted in FIG. 2.

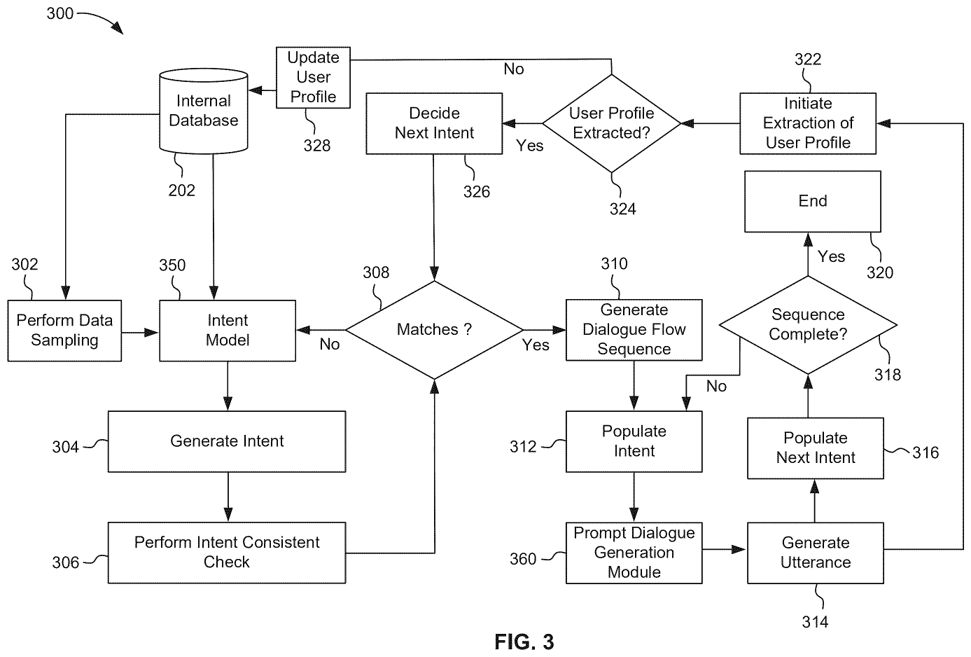

The information extraction module 206 may generate state information by extracting and processing request information from the input (received from the user by the UI/UX module 204). The state information may include intent information. The intent information may identify an intent of the user, which may indicate a purpose or one or more tasks to be performed. For example, the intent of the user may include purchasing a product, searching for hotels/flights, looking for suggestions to use a product/system/tool, greetings or salutations, and/or the like. In some examples, the information extraction module 206 may use an intent model 350 (depicted in FIG. 3) to generate the intent information by identifying the intent of the user in the input. The intent model 350 may be stored in the model database 108. In some examples, the intent model 350 may include one or more of: a few shot intent model and a one-shot multi-intent model. The information extraction module 206 may train the intent model 350 and use the trained intent model 350 to identify the intent of the user from the input associated with the electronic transaction. For example, the intent model 350 including the few shot intent model (also be referred to as few shot domain agnostic model) may be trained using a contrastive learning technique and may be used for the input including a domain agnostic query like “Hi, can you give me more details about this”. The intent model 350 including the one-shot multi-intent model may be used for the input including a domain oriented query like “what is my interest rate”. An exemplary process flow 300 of generating dataset and training the intent model 350 based on the generated dataset is depicted in FIG. 3.

As depicted in FIG. 3, at step 302, the information extraction module 206 retrieves dataset from the internal database 202 and performs data sampling on the retrieved dataset. The dataset may include information about one of: the products, the services, and the entities. At step 304, the information extraction module 206 may generate the intent by processing the sampled dataset along with the user profile of the user using the intent model 350. Upon generating the intent, at step 306, the information extraction module 206 performs intent consistency check by matching the intent with a next intent (which may be predefined initially). At step 308, the information extraction module 206 checks whether the intent matches with the next intent. If the intent does not match with the next intent, the information extraction module 206 enables the intent model 350 to regenerate the intent. If the intent matches with the next intent, at step 310, the information extraction module 206 generates a dialogue flow sequence. Based on the dialogue flow sequence, at step 312, the information extraction module 206 populates the intent. At step 314, the information extraction module 206 generates utterances by processing the populated intent using a prompt dialogue generation model 360. In some examples, the prompt dialogue generation model 360 may be stored in the model database 108 (depicted in FIG. 1) or in the internal database 202 and may include an LLM, an AI model, a ML model, and/or the like. Upon generating the utterance, the information extraction module 206 performs a first set of steps 316-320 and a second set of steps 322-328 in parallel. At step 316, the information extraction module 206 populates a next intent from the dialogue flow sequence. At step 318, the information extraction module 206 checks if the dialogue flow sequence is complete. If the dialogue flow sequence is complete, at step 320, the information extraction module 206 ends a process. If the dialogue flow sequence is not complete, the information extraction module 206 repeats steps 312-318. Alternatively, upon generating the utterance, at step 322, the information extraction module 206 initiates a process of extracting the user profile. At step 324, the information extraction module 206 determines whether the user profile has been extracted from the generated utterances. If the user profile has been extracted based on the generated utterances, at step 326, the information extraction module 206 decides the next intent by modifying the initially predefined next intent. If the user profile has not been extracted from the generated utterances, at step 328, the information extraction module 206 updates the user profile in the internal database 202. Thereafter, the information extraction module 206 may iteratively repeat steps of 302-328 for training the intent model 350 to generate the intent based on the sampling dataset and the updated user profile.

Referring back to FIG. 2, the state information generated by the information extraction module 206 may also include emotional state information, slot information, and constraint information. The emotional state information may indicate an emotional state of the user such as a positive state/reaction, a negative state/reaction, a neutral state/reaction, and/or the like. For example, the positive state/reaction may include “I like this product”, the negative state/reaction may include “Price is very expensive and not in my budget”, and the neutral state/reaction may include “product is ok but want more discount”. The slot information may include a slot name and slot values for the slot name. The slot name may indicate a type or category of information requested by the user, thereby the slot name may be domain specific and may include goal-relevant pieces of information. The slot values may indicate attributes associated with the slot name. For example, the slot name may indicate a product like “smartphone” and the corresponding slot values may indicate “price”, “reviews”, and/or the like. For another example, the slot name may indicate “summer vacation” and the corresponding slot values may indicate “activities”, “tour packages”, and/or the like. For yet another example, the slot name may indicate “environment” and the corresponding slot values may indicate “protection suggestions”. The constraint information may be generated by identifying multi-modal attributes or entities present in the input. For example, if an input includes an image of a phone, then the constraint information may indicate a color of the phone. Therefore, the state information may include the intent information, the emotional state information, the slot information, the constraint information, and/or the like.

Based on the state information, the input classification module 208 may classify the input into a default category or a transaction category. The input classification module 208 may classify the input into the default category, when the input includes greetings or salutations (e.g., the intent). Therefore, the default category may identify the input with the greeting or salutations. For example, an input like “Hello” may be classified into the default category. The input classification module 208 may classify the input into the transaction category, when the input is associated with the electronic transaction (e.g., the intent). Therefore, the transaction category may identify the input associated with the electronic transaction. The input associated with the electronic transaction may include a query or a request for information related to one or more of a product, a service, an entity, and/or the like. For example, an input like “Provide a list of phones with price less than ‘X’” may be classified into the transaction category. For another example, an input like “I am going to my sister's wedding in a country A and need an outfit for the rehearsal dinner and for the wedding itself” may be classified into the transaction category. For yet another example, an input like “Which is the best educational institute for a course A” may be classified into the transaction category. For yet another example, an input like “Do you have suggestions to help the environment” may be classified into the transaction category.

The configuration module 210 may configure the virtual agent to provide a default response to the user for the input classified into the default category. For example, for an input like “Hello’, the configuration module 210 may enable the virtual agent to communicate a default response like “Hello, how can I help you?” to the user. Upon communicating the default response, the UI or UX module 204 may receive further one or more inputs from the user via the virtual agent. In some examples, the one or more inputs may be related to the electronic transaction.

The routing module 212 may route the input associated with the electronic transaction along with the generate state information to the proposition and outcome generation engine 132.

The proposition and outcome generation engine 132 includes an information gathering module 214, a profile generation module 216, an agent aspect modification module 218, a proposition generation module 220, and an outcome determination module 222.

The information gathering module 214 may gather information associated with the electronic transaction, upon receiving the input associated with the electronic transaction from the routing module 212 of the action engine 130. The information associated with the electronic transaction may be gathered from the RAG database 104 including one of: the relational database 114, the vector database 116, and the graph database 118 (depicted in FIG. 1). The information may be related to one or more of: the product, the service, or the entity associated with the electronic transaction. For example, if the input associated with the electronic transaction includes a request for smartphones of a brand A, the information gathering module 214 may gather information related to the smartphones of the brand A from the vector database 116. The gathered information may include prices, colors, specifications, sellers, and/or the like, of the smartphones. For another example, if the input associated with the electronic transaction includes a request for travelling packages for a summer vacation, the information gathering module 214 may gather information related to travelling packages from the vector database 116. The gathered information may include relevant travel agencies, travel packages being provided by the relevant travel agencies, an itinerary of each travel package (e.g., a planned route, stay details, sightseeing places, activities, and/or the like), process of each travel package, and/or the like. For yet another example, if the input associated with the electronic transaction includes a request for suggestions to protect the environment, the information gathering module 214 may gather relevant suggestions for protecting the environment and relationships between the relevant suggestions from the graph database 118.

Upon gathering the information associated with the electronic transaction, the profile generation module 216 may determine if the user profile (also be referred to as user persona) for the user associated with the electronic transaction is stored in the internal database 202 (based on the explicit consent from the user). The user profile of the user may indicate internal goals and intentions, preference aspects, product personalization aspects, purchasing history of the products, stories, relatable scenarios, content consumption aspects demographics, and/or the like. The internal goals may indicate present or future goals of the user. The product personalization aspects may indicate preferences of the user towards brands of the products. The preference aspects may indicate the products, the services, the entities, and/or the like, preferred by the user. For example, the preference aspects may indicate that the user prefers one or more of: products related to a brand A, travelling, cars, gadgets and/or the like. The stories may indicate accomplishment of goals by the user, capabilities of the user, and/or the like. The relatable scenarios may indicate product-use scenarios to which the user may relate, such as growing tomatoes and collecting them from a field, drinking coffee in the morning while the sun is rising, and/or the like. The content consumption aspects may indicate how the user prefers to consume the information related to the products, the services, the entities, and/or the like. For example, the content consumption aspects may indicate that the user prefers to consume the information in form of text, images, videos, audio, and/or the like.

If the user profile of the user is stored in the internal database 202, the profile generation module 216 may gather the user profile for the user from the internal database 202.

If the user profile for the user is not stored in the internal database 202, the profile generation module 216 may determine that there is no minimal information about the user and accordingly generate the user profile for the user. In some examples, the profile generation module 216 may determine the user profile for the user based on the state information generated by the information generation module 206 and historical information associated with the user, demographic information, and/or the like. The state information may include the intent information, the emotional state information, the slot information, the constraint information, and/or the like. The historical information and the demographic information may be gathered from the internal database 202. The historical information may indicate one or more previous electronic transactions associated with the user. It should be noted that usage and storage of the historical information and the demographic information related to the user may be performed based on the explicit consent received from the user.

In some implementations, the profile generation module 216 may also classify the user profile of the user into at least one category. Therefore, similar users may be classified into a same category. The profile generation module 216 may store the user profile in the internal database 202 and update the user profile of the user and the associated category after each electronic transaction. Therefore, the user profile for the user may be stored, maintained, and updated in the internal database 202, based on multiple electronic transactions facilitated between the user and the system 102 over time or multiple sessions.

The agent aspect modification module 218 may modify the aspect of the virtual agent configured to facilitate the electronic transaction based on the information associated with the electronic transaction and the user profile. In some examples, modifying the aspect of the virtual agent may include modifying characteristics of the virtual agent. Examples of the characteristics may include, but are not limited to, sales characteristics, advice characteristics, charitable characteristics, and/or the like. With the sales characteristics, the advice characteristics, and the charitable characteristics, the virtual agent may act as a sales agent, an advice or recommendation agent, and a donation agent, respectively. To illustrate further, if the information associated with the electronic transaction related to a tour package and the user profile indicates that the user prefers traveling and beach activities, the agent aspect modification module 218 may modify the aspect of the virtual agent as the sales agent. If the information associated with the electronic transaction relates to suggestions for protecting environment, the agent aspect modification module 218 may modify the aspect of the virtual agent as the advice agent. If the information associated with the electronic transaction relates to donation for saving children, the agent aspect modification module 218 may modify the aspect of the virtual agent as the donation agent. Therefore, the virtual agent may be operated by dynamically adapting to the information associated with the electronic transaction and the user profile.

In accordance with the modified aspect of the virtual agent, the proposition generation module 220 generates an initial proposition to facilitate the electronic transaction. The initial proposition may include an initial response for the input associated with the electronic transaction. The initial response may include the requested information by the user related to one or more of: the product, the service, and the entity. In some examples, the proposition generation module 220 may generate the initial proposition, based on the state information identified from the input associated with the electronic transaction and the user profile of the user. If the state information is not clearly defined, the proposition generation module 220 may exchange one or more dialogs with the user to establish requirements of the user and accordingly generate the initial proposition. In some other examples, the proposition generation module 220 may consider another user profile of another user with the same category of the user to generate the initial proposition, if the profile generation module 216 does not find the user profile of the user in the internal database 202.

In some examples, the proposition generation module 220 may convert the input associated with the electronic transaction into an embedding or a vector representation. The proposition generation module 220 may also convert the user profile for the user associated with the electronic transaction into an embedding or a vector representation. In the present disclosure, the embedding of the input and the embedding of the user profile may be collectively referred to as an input embedding. In addition, the proposition generation module 220 may convert the gathered information associated with the electronic transaction into an embedding or vector representation, which may be referred to as information embedding. The information embedding may represent the product, or the service, or the entity, for which the information is requested by the user in the input. The proposition generation module 220 may compute a similarity score between the information embedding and the input embedding. Based on the similarity score, the proposition generation module 220 may determine that the gathered information is relevant to the input associated with the electronic transaction and generate the initial proposition from the gathered information. The initial proposition may include at least some part of the gathered information associated with the electronic transaction. For example, consider a scenario where for an input like “Show me some phones related to a brand A with sliver color”, information related to a list of phones of the brand A, and associated details such as: specifications, prices, ratings, and/or the like may be gathered from the RAG database 104. In such a scenario, the proposition generation module 220 may determine that the gathered information is relevant to the input and generate the initial proposition by including the list of phones of the brand A. Therefore, the proposition generation module 220 may generate a product recommendation as the initial proposition.

Additionally, or alternatively, the proposition generation module 220 may generate the initial proposition by selecting an initial engagement strategy from the engagement strategies stored in the internal database 202. The initial engagement strategy may be selected based on the user profile and the policy information associated with the electronic transaction, thereby customizing generation of the initial proposition for the user. The initial engagement strategy may indicate a plan of action to facilitate the electronic transaction. Based on the initial engagement strategy, the proposition generation module 220 may generate the initial proposition to facilitate the electronic transaction. For example, consider a scenario where for an input like “Show me some phones related to a brand A with sliver color”, information related to a list of phones of the brand A, and associated details such as: specifications, prices, ratings, and/or the like, may be gathered from the RAG database 104. However, the proposition generation module 220 may fail to determine the phones of the brand A with silver color. In such a scenario, the proposition generation module 220 may determine from the policy information that phones of the brand A with other colors may have discount offers and from the user profile that the user prefers the brand A. Based on such determination, the proposition generation module 220 may select the initial engagement strategy, which may indicate to provide a list of phones related to the brand A of other than sliver color with offers. Therefore, the proposition generation module 220 may generate the initial proposition by including the list of phones of the brand A other than silver color and respective offers.

Upon generating the initial proposition, the proposition generation module 220 may use the LLM 120 (depicted in FIG. 1) to generate the initial proposition communication for the initial proposition. The initial proposition communication may be a dialog formed for the initial proposition. The proposition generation module 220 may generate a prompt for forming the initial proposition and pass the prompt along with the initial proposition to the LLM 120 to generate the initial proposition. The proposition generation module 220 may provide the initial proposition to the user, via the virtual agent, as the initial proposition communication.

In some implementations, the initial proposition may include one or more initial propositions. The one or more initial propositions may be generated based on exchanging one or more dialogs with the user via the virtual agent. The one or more initial proportions may be provided to the user, via the virtual agent, as initial proposition communications (that are generated using the LLM 120). For example, consider a scenario where the proposition generation module 220 provides a first initial proposition including a list of phones of a brand A with silver color and receives a dialog from the user like “Let me know specifications, ratings, and sellers of a phone A in the list of phones”. In such a scenario, the proposition generation module 220 may generate a second initial proposition by including the requested details (e.g., specifications, ratings, and sellers). For another example, consider a scenario where the proposition generation module 220 provides a first initial proposition including hotels in a country A that comes at $100 and receives a dialog from the user as “What are the complementary services being provided by a hotel A?”. In such a scenario, the proposition generation module 220 may generate a second initial proposition by including the complementary services that can be provided to the user. Therefore, the initial proposition may include the one or more initial propositions generated based on exchange of one or more dialogs with the user, via the virtual agent. Among the one or more initial propositions, a first initial proposition may provide the requested information related to at least one of: the product, the service, and the entity and subsequent initial propositions may provide supplemental information to the information in the first initial proposition.

Upon providing the initial proposition (including the one or more initial propositions) to the user, the proposition generation module 220 may interact, via the virtual agent, with the user to obtain additional information associated with the electronic transaction and the initial proposition. In some examples, the additional information includes, but are not limited to, nonverbal cues, situation information, and emotional state information associated with the user. In some examples, the nonverbal cues may be identified by detecting and analyzing expressions and tonality in addition to an emotion/sentiment detected in words of the additional information. Based on the additional information, the proposition generation module 220 may generate an alternative proposition to the initial proposition. For example, the proposition generation module 220 may generate the alternative proposition by identifying one or more of: a negative reaction of the user, a negative intent, a situation indicating that the user may probably not continue the electronic transaction, and/or the like, from the additional information. As would be understood that the alternative proposition may include one or more alternative propositions. Each of the alternative proposition may persuade, or nudge the user or provide negotiations or advice to the user to continue the electronic transaction.

For generating the alternative proposition, the proposition generation module 220 may generate an alternative engagement strategy to facilitate the electronic transaction based on evaluation of the engagement strategies, the initial engagement strategy, the state information derived from the additional information, the policy information, the user profile, and/or the like. In some examples, the alternative engagement strategy based on consultation may include, but are not limited to, a persuasive insight associated with the alternative proposition, a persuasive insight associated with the user, and a fact supporting the alternative proposition. The alternative engagement strategy may be used to generate the alternative proposition.

In some examples, the proposition generation module 220 may generate the alternative engagement strategy using a Persona Enhanced Multi-Bandit (PMAB) method (also be referred to as PMAB re-enforcement learning (RL)). The PMAB method involves an epsilon greedy strategy and a strategy selection model. The strategy selection model may include a ML model or a ML based RL model for generating the alternative engagement strategy based on evaluation of the engagement strategies, the policy information associated with the electronic transaction, the user profile of the user associated with the electronic transaction, and/or the like. In the present disclosure, the strategy selection model may also be referred to as PMAB model, reward model, and/or the like. The strategy selection model may be stored in the internal database 202 or in the model database 108. As would be understood, generating the alternative engagement strategy may include selecting the alternative engagement strategy from a set of alternative engagement strategies that are derived by prioritizing one or more of the emotional state information, the constraint information, and the intent associated with the user, which is described in detail below.

To generate the alternative engagement strategy in accordance with the PMAB method, the proposition generation module 220 may consider ‘C’ as a set of company policies, C={c1, c2, c3, . . . } and ‘S’ as a set of engagement strategies S={s1, s2, s3, . . . }. The set of company policies ‘C’ may be derived from the policy information associated with the electronic transaction. In some examples, the set of company policies may specify an explicit set of text policies. The set of engagement strategies may be gathered from the internal database 202 and may specify a set of prompts/prompt templates. The set of engagement strategies ‘S’ may include communication schemes or plans of actions to improve a level of engagement of the user with the electronic transaction. In some examples, the set of engagement strategies ‘S’ defined for the product like smartphones may promote various plans of actions in terms of types, prices, specifications, and/or the like. In some other examples, the set of engagement strategies ‘S’ defined for a service like medical services may promote various plans of actions in terms of resources, treatment options, healthy ways to improve health of the user, prices, and/or the like. The proposition generation module 220 may generate entailment scores ‘E’ for the set of company policies ‘C’ and set of engagement strategies ‘S’. The entailment scores ‘E” may be determined from a matrix of the set of company policies ‘C’ and set of engagement strategies ‘S’.

Further, the proposition generation module 220 may derive a set of alternative engagement strategies ‘N’ from the set of company policies ‘C’ and set of engagement strategies ‘S’, each with an entailment score ‘E’ above a predefined score threshold. In some examples, the score threshold may be predefined and/or dynamically adjusted by monitoring a conversation success rate over a period of time for different users. By way of non-limiting example, the score threshold may be predefined as 0.8. For example, each alternative engagement strategy in the set of alternative engagement strategies ‘N’ may be associated with one of: a credibility appeal, a logical appeal, an emotional appeal, a persona-based appeal, and a personal appeal. While implementations of the present disclosure are described in further detail with non-limiting reference to the credibility appeal, the logical appeal, and the emotional appeal, it is contemplated that implementations of the present disclosure may be realized using any other appropriate appeals. The credibility appeal may be a mode of persuasion that persuades the user to engage with the electronic transaction through use of ethical reasonings. For example, an alternative engagement strategy associated with the credibility appeal may be used to generate the alternative proposition like “It is a brand A phone, which ensures its outstanding quality. Many other brand phones with the same quantity do not perform equally well for a long time”, thereby convincing the user to buy the brand A phone while using other sources of authority like other users, certification agencies, and/or the like. The logical appeal may be a mode of persuasion that persuades the user to continue engaging with the electronic transaction through use of logic, reason, data, and facts. For example, an alternative engagement strategy associated with the logical appeal may be used to generate the alternative proposition like “Brand A has a lot of features such as XYZ graphic design with ABC core processor, 15.4 display size, and its rating is 4.1”, thereby providing a logical reasoning to accept the brand A phone. The emotional appeal may may be a mode of persuasion that persuades the user to continue engaging with the electronic transaction by stimulating emotions. For example, an alternative engagement strategy associated with the emotional appeal may be used to generate the alternative proposition like “This phone will be a perfect gift for a photographer; it has all the features and specifications which are necessary for a photographer. Your friend will love this for sure”. The persona-based appeal may be a mode of persuasion that persuades the user to continue engaging with the electronic transaction through use of the respective user profile. For example, an alternative engagement strategy associated with the persona-based appeal may be used to generate the alternative proposition like “I still highly recommend this phone to you because of its special features, particularly the gorgeous titan black color”. The personal appeal may be a mode of persuasion that persuades the user to continue engaging with the electronic transaction through use of personal attributes or interestingness. For example, an alternative engagement strategy associated with the personal appeal may be used to generate the alternative proposition like “This is a great phone and has received overwhelmingly positive reviews globally”.

Upon deriving the set of alternative engagement strategies ‘N’, the proposition generation module 220 may create a set of arms for the user profile of the user ‘P’ or for a category assigned for the user profile of the user and state information ‘I’. The set of arms may represent the set of alternative engagement strategies ‘N’. The state information ‘I’ may indicate the state information derived from the additional information obtained for the initial proposition. For example, if the initial proposition suggested a product, then the state information ‘I’ may include product sentiment, a need for the product, and a concern. The product sentiment may include a positive reaction, a negative reaction, or a neutral reaction. The need for the product may be ‘0’ or ‘1’. The concern for the product may be a set of text values indicating a price, brand, shipping time, and/or the like. Upon creating the arms, the proposition generation module 220 may initiate a first iteration and perform an initialization step, a strategy selection step, and a reward update step using the strategy selection model to select the alternative engagement strategy. During subsequent iterations, the proposition generation module 220 may perform the strategy selection step and the reward update step using the strategy selection model to select the alternative engagement strategy. In some examples, if a new set of alternative engagement strategies are derived from the set of company policies ‘C’ and set of engagement strategies ‘S’ during any of the iterations, the proposition generation module 220 may dynamically adjust parameters of the strategy selection model. In some examples, the parameters of the strategy selection model may include, but are not limited to, weights, exploration parameter, and/or the like. In some examples, the parameters or weights of the strategy selection model may be dynamically adjusted based on the reward generated for the alternative engagement strategies depending on respective responses provided by the user. Therefore, the reward may aid in providing the feedback per alternative engagement strategy and per user profile. In some other examples, the parameters of the strategy selection model may be dynamically or automatically adjusted based on a decision feedback. For example, if a first alternative engagement strategy is successful (e.g., a respective first alternative proposition has been accepted by the user), weights of the first alternative strategy may be frozen or halted. The decision feedback for subsequent alternative strategies may be provided as “Fail or 0” to the strategy selection model, so that the parameters of the strategy selection model may be adjusted in a next epoch based on the decision feedback.

In the initialization step, the proposition generation module 220 may initialize Qᵢ(t)=0, nᵢ(t)=0, for all i=1, . . . , K, wherein ‘Qᵢ(t)’ represents an estimation value of arm ‘I’ at time ‘t’, ‘nᵢ(t)’ represents a count selection indicating a number of times the arm ‘a’ has been selected as the alternative engagement strategy up to time ‘t’, and ‘K’ represents a number of arms. Therefore, initially each of the set of alternative engagement strategies may be assigned with equal value. In the strategy selection step, the proposition generation module 220 may use the strategy selection model to estimate probability and select the arm from the set of arms. In the first iteration, the probability may be estimated as ‘&’ (exploration) and the arm from the set of arms may be selected randomly. For example, the randomly selected arm may be represented as: Iₜ=random choice from {1, . . . , K}. During the subsequent iterations, the probability may be estimated as ‘1−ε’ (exploitation) and accordingly the arm from the set of arms, with the highest estimation value may be selected. The alternative engagement strategy corresponding to the selected arm may be selected for generating the alternative proposition. In the reward update step, the proposition generation module 220, using the strategy selection model, may monitor the response of the user the user to the provided alternative proposition corresponding to the selected arm and generate the state information based on the response. Based on the generated state information, the proposition generation module 220 may determine a success of the selected arm. The success may be further used to determine a reward for the selected arm. If the success includes a final success (e.g., receiving the positive reaction or if the user accepts the alternative proposition corresponding to the selected arm), the reward ‘R^{f}{Iₜ}’ may be determined for the selected arm. If the success includes an incremental success (e.g., receiving the neutral reaction towards the alternative proposition corresponding to the selected arm), the reward ‘R^{s}{Iₜ}’ may be determined for the selected arm. If the success includes an incremental failure (e.g., receiving the negative reaction or rejecting, by the user, the alternative proposition corresponding to the selected arm), the reward ‘Rⁿ{Iₜ}’ may be determined for the selected arm. Also, the proposition generation module 220 may update the count selection for the selected arm as n_{{I}_{ₜ}_{}}(t)=n_{{I}_{ₜ}_{}}(t−1)+1. Further, based on an updated rule defined for the reward, the proposition generation module 220 may update the estimation value for the selected as:

$${Q}_{\{ {I}_{t} \}} ( t ) = {Q}_{\{ {I}_{t} \}} ( t - 1 ) + ( 1 / {n}_{\{ {I}_{t} \}} ( t ) ) ( {R}_{\{ {I}_{t} \}} - {Q}_{\{ {I}_{t} \}} ( t - 1 ) )$$

The updated rule may be indicate variation in reward (e.g., ‘R’ parameters). For example, the ‘R’ parameters may vary as ‘R^{f}’, ‘Rⁿ’, and ‘R^{s}’.

In some other examples, the proposition generation module 220 may generate the alternative engagement strategy using a weight-based utility function. Similar to the PMAB method, the proposition generation module 220 may derive the set of alternative engagement strategies ‘N’ from the set of company policies ‘C’ and set of engagement strategies ‘S’, for the user profile of the user ‘P’ and the state information ‘I’. Thereafter, the proposition generation module 220 may assign a set of weights ‘w’ corresponding to each of the alternative engagement strategies ‘N’. A sum of each of weight vectors may result in ‘1’, which may be referred to as the weight-based utility function. Initially, the set of weights ‘w’ may be equal.

When the proposition generation module 220 determines to generate the alternative proposition, the proposition generation module 220 may use the strategy selection model to assign a reward value of ‘0’ and select each alternative engagement strategy from the set of alternative engagement strategies ‘N’ iteratively starting with the highest weights. The selected alternative engagement strategy may be used to generate the alternative proposition. Based on the response received from the user to the alternative proposition corresponding to the selected alternative engagement strategy (e.g., a next state information), the proposition generation module 220 may use the strategy selection model to compute the reward for the selected alternative engagement strategy. In an example, when the response indicates a shift from the negative reaction to the positive reaction including a soft positive (e.g., “now the product deal looks good for me”, the reward may be computed as ‘+1’, or reverse of ‘-1’. In another example, when the response indicates a shift from the negative reaction to the positive reaction including a strong positive (e.g., “I will buy this product”), the reward may be computed as “agree-cart” or “dialog_act+10”. As would be understood, the reward may computed by dynamically varying configurations of parameters such as “agree-cart”, “dialog_act+10”, and/or the like. For example, the “dialog_act+10” may be configured as “dialog_act+20”. Based on the reward and a step value, the proposition generation module 220 may update the weights of each in the set of alternative engagement strategies. The step value may indicate whether to increment or decrement the weights of the set of alternative engagement strategies. For example, the step value may be represented as ‘1/N’. In some examples, if the computed reward includes a positive reward, the weights may be updated by multiplying the weights with the reward. If the computed reward includes a negative reward, the weights may be reduced by multiplying the reward value with the step value. Further. the proposition generation module 220 may iteratively perform steps of updating the weights of the set of alternative engagement strategies ‘N’ based on the reward, selecting the alternative engagement strategy from the set of alternative engagement strategies, and updating the reward, until reaching the reward of pre-defined value (e.g., ‘-3’ indicating a predefined number of turns or persuasion, or issuance of a robust negative affect by the user, or end statement like “closing” interaction). For example, based on the user profile and the state information derived from the additional information provided to the initial proposition, the proposition generation module 220 may select a first alternative engagement strategy with the logical appeal for generating a first alternative proposition. Based on a state information derived from a response received from the user for the first alternative proposition, the proposition generation module 220 may select a second alternative engagement strategy with the emotional appeal for generating a second alternative proposition. The proposition generation module 220 may further continue with selecting subsequent alternative engagement strategies, until reaching the reward of pre-defined value.

In some implementations, if the additional information received for the initial proposition includes multiple dialogs and multiple reactions of the user, the proposition generation module 220 may generate the alternative engagement strategy by considering the previous electronic transactions along with the evaluation of the engagement strategies, the initial engagement strategy, the state information derived from the additional information, the policy information, the user profile, and/or the like. For example, consider a scenario where the proposition generation module 220 receives the additional information from the user to the initial proposition as “I am intrigued with the features of this product; however, I have never heard of this brand. I also am not sure if I can afford this. Do you have something cheaper?”. As the additional information include multiple dialogs and multiple reactions, for example, a positive reaction to the product, a negative reaction to the brand, and intent including a request for negotiation of price and a request for options, the proposition generation module 220 may consider the previous electronic transactions along with the evaluation of the engagement strategies, the initial engagement strategy, the state information derived from the additional information, the policy information, the user profile, and/or the like, for generating the alternative engagement strategy. The alternative engagement strategy may provide a plan of action to persuade the user about the legitimacy of the brand, provide the user an enticing discount, and suggest similar features in different brand in the same alternative proposition or in subsequent alternative propositions.

Based on the generated/selected alternative engagement strategy, the proposition generation module 220 may generate the alternative proposition. In some implementations, the alternative proposition may include, but are not limited to, a persuasion, a nudge, a negotiation, and advice associated with the electronic transaction. The persuasion may be associated with the credibility appeal, the logical appeal, the emotional appeal and/or the like (already described in detail above along with the alternative engagement strategies). The nudge may influence the user to continue engaging with the electronic transaction. In some examples, the nudge may include a credibility nudge, a logical nudge, an emotional nudge, and/or the like. The credibility nudge may indicate positive reviews or authenticity of the suggested product, service, entity, and/or the like. For example, upon receiving a negative reaction from the user with respect to a price of a suggested product like Television (TV), the alternative proposition including the credibility nudge may be generated as “This product has received fantastic reviews like “This TV is crisp and clear image quality”. For example, upon receiving a negative reaction of the user with respect to a brand of a suggested product, the alternative proposition including the credibility nudge may be generated as: “This product seems to match your requirements the best, it is small in size and is available at a great price. Also, your credit card A will give you an additional 5 percent discount”. The emotional nudge may indicate facts associated with the suggested product, service, entity, and/or the like, which may be of interest to the user. For example, when the user does not want to purchase a suggested product because of lack of information, the alternative proposition including the emotional nudge may be generated as “even XYZ actor promoted this product”.

The negotiation may include a counteroffer, a discounted price, an alternative service, an alternative product, an additional service, an additional product, and a modified service, or a modified product. For example, consider a scenario where the proposition generation module 220 receives the additional information to the initial proposition as “Offers do not matter to me, I need a phone of the brand A with silver color only”. In such a scenario, the proposition generation module 220 may generate the alternative proposition including the negotiation, which may be indicative of providing the phone of the brand A by customizing a back cover for the phone with silver color. For another example, consider a scenario where the proposition generation module 220 receives the additional information to the initial proposition as “This is bit expensive still”. In such a scenario, the proposition generation module 220 may generate the alternative proposition including the negotiation as “Just because you are such a good customer, we can give you free shipping” or “We can give you 10% off on the entire deal if you book today”.

The advice may include a targeted advice associated with the electronic transaction. The advice may clarify required facts with the user with the purpose of changing opinion of the user. For example, the proposition generation module 220 may generate the alternative proposition including the advice as “Going digital can reduce paper waste, save trees, and reduce carbon footprint, it's a small but impactful step towards a greener future”.

Once the alternative proposition is generated based on the selected alternative engagement strategy, the proposition generation module 220 may use the LLM 120 (depicted in FIG. 1) to generate the alternative proposition communication. The proposition generation module 220 may generate a prompt for alternative proposition communication and provide the prompt along with the generated alternative engagement strategy to the LLM 120 to provide the alternative proposition communication. The alternative proposition communication may be in a form of dialog to be communicated to the user. The proposition generation module 220 may communicate, via the virtual agent, the alternative proposition to the user as an alternative proposition communication.

The outcome determination module 222 may receive, via the virtual agent, a response to the alternative proposition (including the one or more alternative propositions) from the user and determine an outcome for the electronic transaction. The outcome determination module 222 may determine the outcome for the electronic transaction, based on the response to the alternative proposition, the policy information associated with the electronic transaction, and/or predefined persuasive parameters. The outcome may include a successful transaction or a failure transaction.

The outcome determination module 222 may determine the outcome for the electronic transaction as the successful transaction, based upon determining a positive reaction of the user towards the alternative proposition, from the response. For example, if the user provides a response to an alternative proposition (including the nudge) as “I changed my mind this time, I will go with the suggested TV”, the outcome determination module 222 may determine the outcome for the electronic transaction as the successful transaction and may close the electronic transaction by placing an order for the TV. For another example, if the user provides a response to an alternative proposition (including a negotiated deal) as “this is a great deal”, the outcome determination module 222 may determine the outcome for the electronic transaction as the successful transaction and may close the electronic transaction by accepting the deal. For yet another example, if the user provides a response to an alternative proposition (including advice) as “That sounds nice, I will try this!”, the outcome determination module 222 may determine the outcome for the electronic transaction as the successful transaction based on acceptance of the advice by the user.

The outcome determination module 222 may determine the outcome for the electronic transaction as the failure transaction, based upon one or more of: i) determining the negative reaction of the user after reaching a predefined state threshold, ii) receiving end statements or closing statements from the user; iii) determining that providing of further or subsequent alternative propositions are against the policy information; and iv) determining that a predefined number of persuasive turns has been reached for the user. The predefined state threshold may indicate a maximum number of negative reactions (e.g., 3) that can be received from the user for the same input. The predefined number of persuasive turns may indicate a maximum number of alternative propositions that can be provided to the user. For example, if the user provides the negative reaction (e.g. “This deal is still expensive) even after three negotiations and further negotiation is not possible in accordance with the policy information, the outcome determination module 222 may determine the outcome for the electronic transaction as the failure transaction and may close the electronic transaction by rejecting the deal. For another example, if the user provides an end statement like “this is not cheap enough. I will not book it” after the predefined number of persuasive turns, the outcome determination module 222 may determine the outcome for the electronic transaction as the failure transaction and may close the electronic transaction. For yet another example, if the user requests for further discount offers and the discount offers have already been exhausted for the user, the outcome determination module 222 may determine the outcome for the electronic transaction as the failure transaction and may close the electronic transaction.

In some implementations, the proposition generation module 220 may analyze the response received to the alternative proposition and generate a future proposition. The proposition generation module 220 may implement the future proposition in a future electronic transaction associated with the user or another user. For example, consider a scenario the future proposition generated for the user may include holiday packages for summer vacation and further another user having the user profile classified into the same category of the user may request for the holiday packages for the summer vacation. In such a scenario, the proposition generation module 220 may provide the future proposition to another user.

An exemplary electronic transaction facilitated between a user 1 and the system 102 in accordance with implementations of the present disclosure is illustrated in below table 1:

TABLE 1
Exemplary use case of determining the outcome for the electronic transaction, while
providing initial propositions and alternative propositions

| Input/Dialog/Additional | | |
|---|---|---|
| Information/Response | State Information | Proposition Generation |
| User 1: | Intent Information: request for | |
| I want to go for a good | recommendation | |
| summer vacation with | Slot Information: summer vacation, | |
| my family, do you have | family | |
| any suggestions. | | |
| Virtual Agent: | User 1: | First Initial Proposition: |
| How about a holiday to | User Profile: Unknown | For the user 1, the user |
| XYZ beach with | User History: Unknown | profile and the user history |
| activities like | Initial Engagement Strategy: Sell | (previous electronic |
| snorkeling, jet skiing | package deal | transactions) are unknown. |
| etc. The price is very | (beach package, safari package) | Therefore, the proposition |
| fair at 20000 dollars. | Gathered Information: Beach package | and outcome generation |
| | deal with activity, safari package deal | engine 132 may consider |
| | with activity, only hotels waterfall, only | the user profile and the |
| | hotels beach. | user history of similar user |
| | User 2: | (belonging to the same |
| | User profile: Likes relaxation | category), for example, the |
| | User History: Beach, Activities like | user 2 and generate a first |
| | yoga | initial proposition. The first |
| | Initial Engagement Strategy: Sell | initial proposition may be |
| | package deal (beach package, safari | based on the initial |
| | package) | engagement strategy, the |
| | Gathered Information: Beach package | user profile, the user |
| | deal with activity, safari package deal | history of the user 2. The |
| | with activity, only hotels waterfall, only | initial proposition includes |
| | hotels beach. | beach holiday package |
| | | with activities. If the |
| | | proposition and outcome |
| | | generation engine 132 did |
| | | not consider the user |
| | | profile and the user history |
| | | of the user 2, then the first |
| | | initial proposition may |
| | | include a list of beach |
| | | villas. Therefore, |
| | | considering the user profile |
| | | and/or the user history of |
| | | the similar user may |
| | | improve quality of the |
| | | initial proposition. |
| | | Further, the proposition and |
| | | outcome generation engine |
| | | 132 may also generate a |
| | | user profile for the user 1. |
| User 1: | Intent Information: high price | |
| The package is | Emotional State Information: negative | |
| expensive. I am also not | reaction | |
| interested in adventure | Slot information: adventure sports | |
| sports. | | |
| Virtual Agent: | | Second Initial Proposition: |
| I understand, since you | | Upon receiving the |
| are not keen on | | negative reaction from the |
| activities, I will replace | | user and a change in the |
| the adventure activities | | slot information, the |
| with yoga and massage. | | proposition and outcome |
| This will also bring | | generation engine 132 may |
| down your cost by 10 | | fetch the policy |
| percent. | | information, which may |
| | | indicate that maximum |
| | | discount is 8 percent. After |
| | | exhausting maximum |
| | | discount, a membership |
| | | may be provided to the |
| | | user if the negative |
| | | reaction is received from |
| | | the user even after |
| | | providing the maximum |
| | | discount. Accordingly, the |
| | | proposition and outcome |
| | | generation engine 132 may |
| | | generate a second initial |
| | | proposition. |
| | | The proposition and |
| | | outcome generation engine |
| | | 132 may update the user |
| | | profile of the user 1. |
| User 1: | Intent Information: high price | |
| Fabulous. I still think it | Emotional State Information: negative | |
| is way above my budget | reaction | |
| Virtual Agent: | Persuasion: Emotional appeal | First Alternative |
| I can bring the price to | | Proposition: |
| ‘y’ value. This beach is | | The proposition and |
| beautiful, and you will | | outcome generation engine |
| not regret your stay | | 132 may identify the |
| here. | | negative response from the |
| | | user 1 to the initial |
| | | proposition. Therefore, the |
| | | proposition and outcome |
| | | generation engine 132 may |
| | | generate a first alternative |
| | | proposition to persuade the |
| | | user to continue engaging |
| | | with the electronic |
| | | transaction. The |
| | | proposition and outcome |
| | | generation engine 132 may |
| | | select a first alternative |
| | | engagement strategy with |
| | | the emotional appeal, based |
| | | on the user profile and the |
| | | state information. Based on |
| | | the selected alternative |
| | | engagement strategy, the |
| | | proposition and outcome |
| | | generation engine 132 may |
| | | generate the first alternative |
| | | proposition, which |
| | | persuades the user 1 to |
| | | facilitate the electronic |
| | | transaction through use of |
| | | emotional feelings. |
| User 1: | Intent Information: request for further | |
| I still want more | discount | |
| discount. | Emotional State Information: Neutral | |
| | reaction | |
| Virtual Agent: | | Second Alternative |
| How about we provide | | Proposition: |
| you with a lifetime | | The policy information |
| membership. This | | indicates that maximum |
| normally costs 100 | | discount is x percent. |
| dollars, but for you it is | | Therefore, after exhausting |
| free. | | maximum discount, the |
| | | proposition and outcome |
| | | generation engine 132 may |
| | | generate a second |
| | | alternative proposition, |
| | | which persuades the user to |
| | | facilitate the electronic |
| | | transaction, via providing |
| | | free membership. |
| User 1: | Emotional State Information: Neutral | |
| Great. What more can | reaction | |
| you do? | | |
| Virtual Agent: | Persuasion: logical appeal | Third Alternative |
| This is our best offer. | | Proposition: |
| Our rates are very | | As the user provides the |
| competitive, and we | | neutral reaction to the |
| hope we can book a | | second alternative |
| great vacation for you. | | proposition, the proposition |
| | | and outcome generation |
| | | engine 132 may generate a |
| | | third alternative proposition |
| | | through use of logic, facts, |
| | | reasons, and/or the like. |
| User 1: | Intent: Negative reaction | |
| This is not cheap | | |
| enough. I will not book | | |
| it. | | |
| Virtual Agent: | | The proposition and |
| Sorry to hear that. We | | outcome generation engine |
| are sorry we could not | | 132 may determine the |
| do more. If you have | | outcome for the electronic |
| new vacation | | transaction as failure |
| requirements, we are | | transaction and end the |
| happy to help. | | electronic transaction, as |
| | | the discount exhausted and |
| | | the user has provided the |
| | | negative reaction on the |
| | | same request for 3 times. |

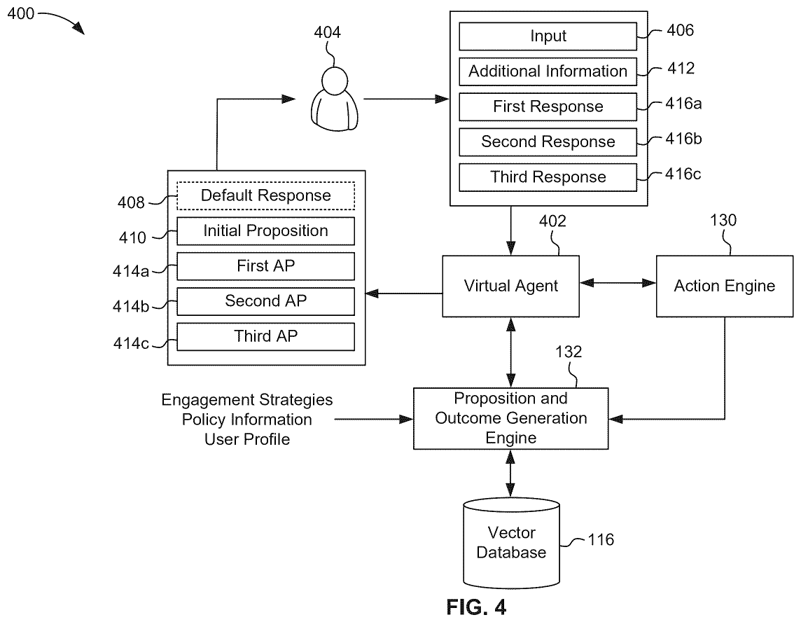

FIG. 4 depicts an exemplary illustration 400 of facilitating the electronic transaction between the user/user device 110 and the system 102, while deriving the outcome for the electronic transaction, in accordance with implementations of the present disclosure. The example illustration 400 may be described using the interface tool 128, the action engine 130, and the proposition and outcome generation engine 132 of the transaction manager 126 in the system 102, as described in relation to FIGS. 1-2.

The interface tool 128 may execute a virtual agent 402 on the user device 110 (depicted in FIG. 1), which enable the user 404 of the user device 110 to interact with the system 102. The virtual agent 402 may receive an input 406 from the user. Upon receiving the input 406, the action engine 130 may derive the state information from the input. The state information may include the intent information, the slot information, the emotional state information, and the constraint information. Based on the state information, the action engine 130 may identify whether the input 406 includes greetings or the input is associated with the electronic transaction. If the input is associated with the electronic transaction, the action engine 130 may enable the virtual agent 402 to provide a default response to the user for the greetings. An exemplary input including the greetings and an exemplary default response are described below:
User 404: Hi (Input 406)
Virtual Agent 402: Hi, how can I help you? (408)

If the input is associated with the electronic transaction or if the user provides the input 406 associated with the electronic transaction after the default transaction, the action engine 130 routes the input along with the state information to the proposition and outcome generation engine 132. The proposition and outcome generation engine 132 may gather the information associated with the electronic transaction from the vector database 116 and the user profile of the user 404 from the internal database 202. If the user profile does not exist for the user 404, the proposition and outcome generation engine 132 initiates a process of generating the user profile for the user 404 based on the state information generated from the input 406, the previous electronic transactions, the demographic information, and/or the like. Therefore, when there is a minimal information about the user 404, the proposition and outcome generation engine 132 may initiate building an identity for the user 404. Based on the gathered information, the user profile, and/or the initial engagement strategy, the proposition and outcome generation engine 132 may generate the initial proposition, for example, a first initial proposition, and a corresponding first initial proposition communication using the LLM 120 (depicted in FIG. 1). The proposition and outcome generation engine 132 may provide the initial proposition communication indicating the first initial proposition to the user 404, via the virtual agent 402. In response to the initial proposition communication, the user 404 may request for supplemental information. In such a scenario, the proposition and outcome generation engine 132 may generate a second initial proposition and provide a second initial proposition communication indicating the second initial proposition to the user 404, via the virtual agent 402. The first and second initial propositions may be collectively referred to as an initial proposition 410, as depicted in FIG. 4. An exemplary initial proposition 410 provided to the user 404 in response to the input 406 associated with the electronic transaction is depicted below:
User 404: I am travelling to place XYZ and show me some hotels that comes at $100 (Input 406)
Virtual Agent 402: The hotel ABC Inn meets all your requirements; it comes at $100 for a single room and $140 for deluxe. It's located at 5th Avenue, Place XYZ. Would you like to book here? (First Initial Proposition)
User 404: How is the food and the service here? (Dialog from the user requesting for supplemental information)
Virtual Agent 402: You can expect both the food and the service to be excellent because the hotel ABC Inn has received several awards and has also received endorsements from famous critics. It's also a favorite among travel magazines! (Second Initial Proposition)

Upon providing the initial proposition 410, the proposition and outcome generation engine 132 may receive additional information 412 (e.g., nonverbal cues, situation information, and emotional state information) from the user 404 to the initial proposition 410. Based on the additional information 412 and the user profile of the user 404, the proposition and outcome generation engine 132 may derive a set of alternative engagement strategies from the policy information (gathered from the policy database 106) and the engagement strategies (gathered from the internal database 202) and select an alternative engagement strategy, for example, a first alternative engagement strategy associated with the logical appeal. Based on the first alternative engagement strategy, the proposition and outcome generation engine 132 may generate a first alternative proposition 414a (indicated as first AP in FIG. 4) and a corresponding first alternative proposition communication using the LLM 120. In an example herein, the first alternative proposition 414a may include a nudge, which influences the user 404 to continue engaging with the electronic transaction. The proposition and outcome generation engine 132 may provide the first alternative proposition communication indicating the first alternative proposition 414a to the user 404, via the virtual agent 402. An exemplary first alternative proposition provided to the user 404 in response to the additional information 412 received for the initial proposition 410 is depicted below:
User 404: Oh, is that so, in that case it seems like a good choice, but $140 seems to be above my budget. (Additional information 412 to the initial proposition 410)
Virtual Agent 402: I understand that $140 may be high, however I can assure you that it will be well worth the price and I'm sure that the locals, guests and the critics feel the same! There is also an option for a single room at $100. (First Alternative Proposition 414a)

The proposition and outcome generation engine 132 may receive a first response 416a from the user to the first alternative proposition 414a, via the virtual agent 402. Based on the response 416a, the proposition and outcome generation engine 132 may derive the state information, for example, including the intent information and the emotional state information. In an example herein, the emotional state information may indicate a neutral state, and the intent information may indicate a request for negotiation. In such a scenario, the proposition and outcome generation engine 132 may use the strategy selection model to compute the reward for the first alternative proposition 414a and accordingly update weights of the alternative engagement strategies based on the reward. Thereafter, based on the derived state information with respect to the first alterative proposition 414a, the proposition and outcome generation engine 132 may select a second alternative engagement (with the highest weights), for example, associated with the credibility appeal. Based on the second alternative engagement strategy, the proposition and outcome generation engine 132 may generate a second alternative proposition 414b (indicated as second AP in FIG. 4) and a corresponding second alternative proposition communication using the LLM 120. In an example herein, the second alternative proposition 414b may include a negotiation, which influences the user 404 to continue engaging with the electronic transaction. The proposition and outcome generation engine 132 may provide the second alternative proposition communication indicating the second alternative proposition to the user 404, via the virtual agent 402. An exemplary second alternative proposition 414b provided to the user 404 upon receiving the first response 416a for the first alternative proposition is depicted below:
User 404: I'm interested in the deluxe room, but I would like it at $110, is that possible?(First response 416a to the first alternative proposition 414a)
Virtual Agent 402: $110 would be a bit too low for the deluxe room, how about $130? (Second Alternative Proposition 414b including the negotiation)

The proposition and outcome generation engine 132 may receive a second response 416b from the user to the second alternative proposition 414b, via the virtual agent 402. Based on the response 416b, the proposition and outcome generation engine 132 may derive the state information, for example, including the intent information and the emotional state information. In an example herein, the emotional state information may indicate a positive reaction, and the intent information may indicate a request for further negotiation. In such a scenario, the proposition and outcome generation engine 132 may use the strategy selection model to compute the reward for the second alternative proposition 414b and accordingly update weights of the alternative engagement strategies based on the reward. Thereafter, based on the derived state information with respect to the second alterative proposition 414b, the proposition and outcome generation engine 132 may select a third alternative engagement strategy (with the highest weights). Based on the second alternative engagement strategy, the proposition and outcome generation engine 132 may generate a third alternative proposition 414c (indicated as third AP in FIG. 4) and a corresponding third alternative proposition communication using the LLM 120. In an example herein, the third alternative proposition 414c may indication of accepting the further negotiation, as the policy information allows for the further negotiation. The proposition and outcome generation engine 132 may provide the third alternative proposition communication indicating the acceptance of the further negotiation. An exemplary third alternative proposition 414c provided to the user 404 upon receiving the second response 416b for the second alternative proposition is depicted below:
User 404: $125 and we can proceed to checkout! (Second response 416b to the second alternative proposition 414b)
Virtual Agent 402: Alright, done deal. (Third alternative proposition 414c indicating the acceptance of the further negotiation)

Based on a third response 416c from the user to the third alternative proposition 414c, the proposition and outcome generation engine 132 may determine the outcome for the electronic proposition as the successful transaction and close the electronic transaction by accepting the deal. An exemplary outcome for the electronic transaction is depicted below:
User 404: Great! (Third response 416c to the third alternative proposition 414c)
Virtual Agent 402: We can proceed to checkout! (Outcome: Successful transaction)

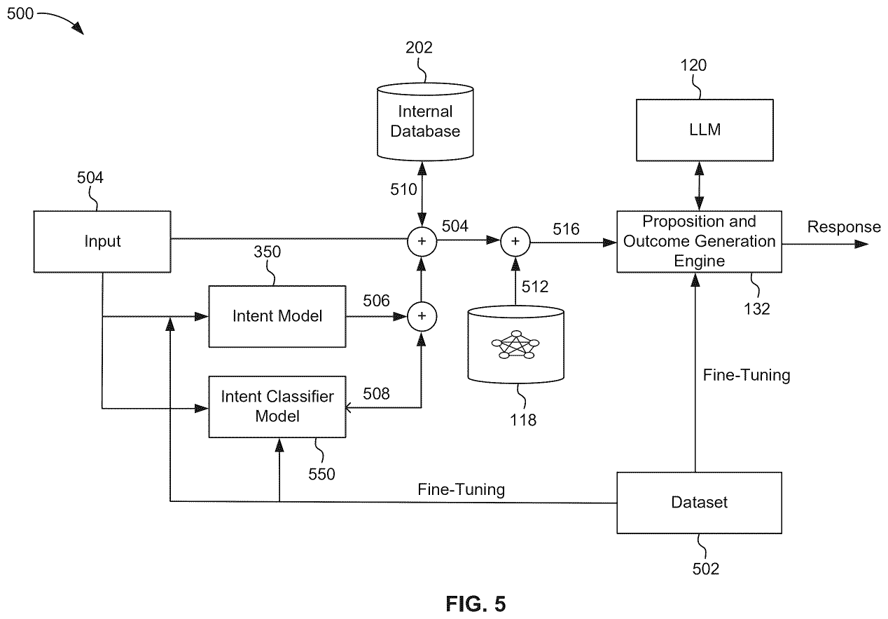

FIG. 5 depicts an exemplary illustration 500 of generating the alternative proposition including the advice or suggestions, in accordance with implementations of the present disclosure. Implementations of the present disclosure are described in FIG. 5 by considering the virtual agent as a sustainability advisor, which may be used to generate the advice or suggestions for protecting environment, however it should be obvious to a person skilled in the art that other similar use cases or domains may be considered.

For generating the advice or suggestions to protect the environment, the proposition and outcome generation engine 132 may fine-tune the LLM 120 (depicted in FIG. 1), the intent model 350 (depicted in FIG. 3), and an intent classifier model 550, based on dataset 502. The LLM 120 may be include a pretrained LLM or a previously fine-tuned LLM. In some examples, the LLM 120, the intent model 350, and the intent classifier model 550 may be fine-tuned during an offline process with prior training. The intent classifier model 550 may be used to identify intent of an output generated by the virtual agent to inputs or requests of the user associated with the user device 110 (depicted in FIG. 1). In an example herein, a LLM may be integrated with the virtual agent to generate the output, and the output may include the default response, dialogs for establishing the requirements of the user, or the advice or suggestions for protecting the environment. The dataset 502 may include conversational or interaction data associated with previous electronic transactions monitored over time. The previous electronic transactions may be related to the environment. In some examples, the proposition and outcome generation engine 132 may use one of: an LLM, an AI model, a ML model, and/or the like, for processing the conversational or interaction data and generate the dataset 502. The LLM, or the AI model, or the ML model used by the proposition and outcome generation engine 132 may be a pretrained model. In some examples, the dataset 502 may include suggestions (e.g., statistical support), relational advantages (e.g., stories), an inspirational appeal, and/or the like. Therefore, the fine-tuned LLM 120, the intent model 350, and the intent classifier model 550 may be used to provide the advice or suggestions for protecting the environment, which may allow to gather information about the suggestions for protecting the environment by accessing different data sources other than the RAG database 104 as well.

Further, as depicted in FIG. 5, upon receiving an input 504, the proposition and outcome generation engine 132 may use the intent model 350 to generate intent information indicating intent of the user (hereinafter referred to as input intent 506). The proposition and outcome generation engine 132 may enable the virtual agent integrated with the LLM to generate an output and use the intent classifier model 550 to generate intent information indicating intent of the output (hereinafter referred to as output intent 508). Further, the proposition and outcome generation engine 132 may gather historical information and user profile 510 associated with the user from the internal database 202. The historical information may include the previous electronic transactions (related to the environment) associated with the user. In addition, the proposition and outcome generation engine 132 may also gather requested information 512 (e.g., information related to the suggestions for protecting the environment) from the graph database 118. The proposition and outcome generation engine 132 may generate a context 516 by aggregating the input intent 506, the output intent 508, the historical information and user profile 510, the requested information 512, and the input 504. The proposition and outcome generation engine 132 may use the LLM 120 (fine-tuned) to generate the initial proposition or the alternative proposition based on the generated context 516. The initial proposition may may act as a response herein for the input 504, providing the requested information/suggestion. The alternative proposition may act as a response herein for the input 504. providing the advice or suggestions for protecting the environment.

An exemplary electronic transaction facilitated between the user and the system 102, via the virtual agent acting as the sustainability advisor is described below:
User: Do you have any suggestions for me today?
Virtual Agent (Sustainability advisor): How about suggesting legislation that promotes environmental protection? It's a simple way to make a big impact. (Providing the suggestion, by identifying from the user profile that user is open to suggestions and gathering facts related to protecting the environment)
User: How will that help?
Virtual Agent (Sustainability advisor): Supporting environmental legislation can lead to a cleaner and healthier environment for everyone. (Explaining the benefits)

Another exemplary electronic transaction facilitated between the user and the system 102, via the virtual agent acting as the sustainability advisor is described below:
User: Do you have any suggestions to help the environment?
Virtual Agent (Sustainability advisor): Have you considered participating in beach or park clean ups? (Initial proposition)
User: That's not for me. It sounds like a lot of work.
Virtual Agent (Sustainability advisor): Participating in clean ups can help reduce pollution and protect wildlife. It's also a great way to meet likeminded people. (First Alternative Proposition including a suggestion)
User: Not interested, anything else (Negative reaction)
Virtual Agent (Sustainability advisor): Have you considered using a programmable thermostat to optimize energy usage? According to consumer reports, magazine, programmable thermostats can reduce energy bills by about $180 a year. (Second Alternative Proposition including an alternate suggestion)
User: Not really, how di I do this? (Neutral reaction)
Virtual Agent (Sustainability advisor): You can use a programmable thermostat to automatically adjust your energy usage according to the energy usage of the environment. It's a great way to save money and reduce your carbon footprint. (Second Alternative Proposition including benefits)
User: ok, I will give it a try (Positive reaction)
Virtual Agent (Sustainability advisor): That's great to hear! (Outcome: successful transaction)

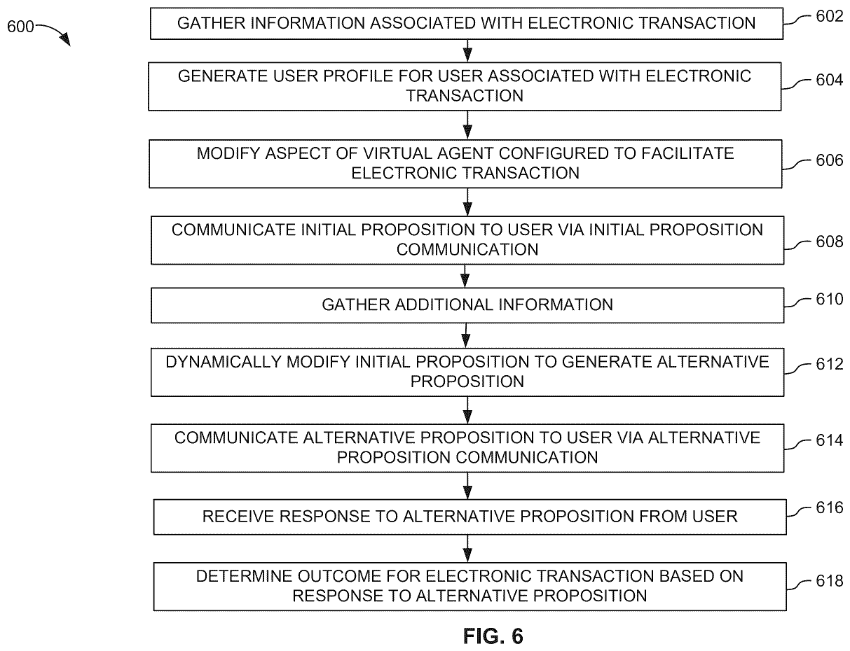

FIG. 6 is a flow diagram that presents a method 600 for determining the outcome for the electronic transaction over the computer network 112, in accordance with implementations of the present disclosure. In some implementations, the method 600 may be executed by the processor 122 (including the one or more processors) using the transaction manager 126, as described in relation to FIGS. 1-5.

At step 602, the method 600 includes gathering the information associated with the electronic transaction. The information may be associated with one or more of a product, service, or entity associated with the electronic transaction. In some examples, the information may be gathered from the RAG database 104 including one of: the relational database 114, the vector database 116, and the graph database 118.

At step 604, the method 600 includes generating the user profile for the user associated with the electronic transaction. The user profile may be generated based one information associated with one or more previous electronic transactions, demographic information, emotional state information, constraint information, and intent information, which are described in detail in conjunction with FIG. 2, therefore repeated description is omitted herein for sake of brevity.

Based on the information associated with the electronic transaction and the user profile, at step 606, the method includes modifying an aspect of the virtual agent configured to facilitate the electronic transaction. Modifying the aspect of the virtual agent is described in detail along with the agent aspect modification module 218 of the transaction manager 126 in FIG. 2.

At step 608, the method 600 includes communicating the initial proposition to the user via the initial proposition communication. The initial proposition is based on initial engagement strategy to facilitate the electronic transaction. In some examples, generating the initial proposition communication may include providing the initial engagement strategy to the LLM 120 to generate the initial proposition communication.

At step 610, the method 600 includes interacting, via the virtual agent, with the user to gather additional information associated with the electronic transaction and the initial proposition. In some examples, the additional information may include one or more of: nonverbal cues, situation information, and the emotional state information associated with the user.

At step 612, the method 600 includes dynamically modifying the initial proposition to generate the alternative proposition. Generating the alternative proposition includes generating the alternative engagement strategy to facilitate the electronic transaction based on the initial engagement strategy and the additional information. The alternative engagement strategy may be generated based on adjusting of weighting values of the strategy selection model configured to evaluate the engagement strategies. The alternative engagement strategy may be based on one or more of: the credibility appeal, the logical appeal, and the emotional appeal. The alternative engagement strategy based on consultation may include one or more of; a persuasive insight associated with the alternative proposition, a persuasive insight associated with the user, and a fact supporting the alternative proposition. In some examples, the alternative engagement strategy may be generated based on the PMAB method or the weight-based utility function, which is described in detail along with the proposition generation module 220 of the transaction manager 126 in FIG. 2, therefore repeated description is omitted herein for sake of brevity. The alternative engagement strategy may be used to generate the alternative proposition. In some examples, the alternative proposition may include one or more of: the persuasion, the nudge, the negotiation, and the advice. Exemplary alternative propositions including the nudge and the negotiation are illustrated in FIGS. 2 and 4. Exemplary alternative propositions including the advice are illustrated in FIG. 5.

Upon generating the alternative proposition, at step 614, the method 600 includes communicating the alternative proposition to the user via the alternative proposition communication. In some examples, generating the alternative proposition communication may include providing the alternative engagement strategy to the LLM 120 to generate the alterative proposition communication.

At step 616, the method includes receiving the response to the alternative proposition from the user. Based on the response to the alternative proposition, at step 618, the method 600 includes determining the outcome for the electronic transaction. The outcome may be determined as the successful transaction or the failure transaction, which is described in detail along with the outcome determination module 222 of the transaction manager 126 in FIG. 2.

Implementations of the present disclosure provide technical solutions to provide multiple technical improvements and address drawbacks of the virtual agent being employed by the existing online system. Implementations of the present disclosure enable generation of the initial proposition and the alternative proposition for facilitating the electronic transaction. The alternative proposition may be generated based on one or more of: the user profile, the state information, the set of alternative engagement strategies, and the policy information. The alternative proposition may persuade/nudge or negotiate or influence the user to continue engaging with the electronic transaction, thereby variable and relevant options may be provided that may meet requirements of the user to continue engaging with the electronic transaction. Further, set of alternative engagement strategies and/or the policy information may be continuously updated using a learning-based framework based on a set of rewards, so that the set of alternative engagement strategies may be adaptable to incorporate user indirect feedback and accommodate the policy information. Therefore, with the proposed implementations, the system may build a trust or rapport with the user after a few sets of electronic transactions/interactions/conversations, which may enable the system to determine what is to be suggested to the user that enhances satisfaction of the user. For example, the system may initially identify that the user may be technical person and accordingly providing the initial or alternative propositions. After the few sets of the electronic transactions/interactions/conversations, the system may also identify that the user may be entrepreneur operating an enterprise. Accordingly, the system may provide the initial or alternative propositions to improve operations of the enterprise along with the technical details, thereby building the trust or rapport with the user.

With the initial proposition and the alternative proposition, implementations of the present disclosure may ensure deliver of reliable information to the user. Implementations of the present disclosure may also provide predictable outputs through calibration to deliver consistent responses (including the reliable information) that align with expected outcomes, reducing unexpected interactions with users. This includes consistency in the responses by maintaining a uniform response structure and preserving a conversational context. Implementations of the present disclosure may also provide for efficiencies in terms of technical resource consumption, which also includes minimizing latency (even under heavy loads). Implementations of the present disclosure also enable tailored control enabling bespoke customization and fine-tuning behavior of the LLM to specific needs and preferences.

Implementations of the present disclosure may also provide flexibility in integration of the virtual agent into existing workflows and software systems (e.g., customer relationship management (CRM) systems, enterprise resource planning (ERP) systems). This includes, for example, handling structured data and unstructured data and seamless connection with existing databases, file systems, and the like to enable unified processes. Implementations of the present disclosure also enhance scalability to scale in response to demand without compromising quality or performance.

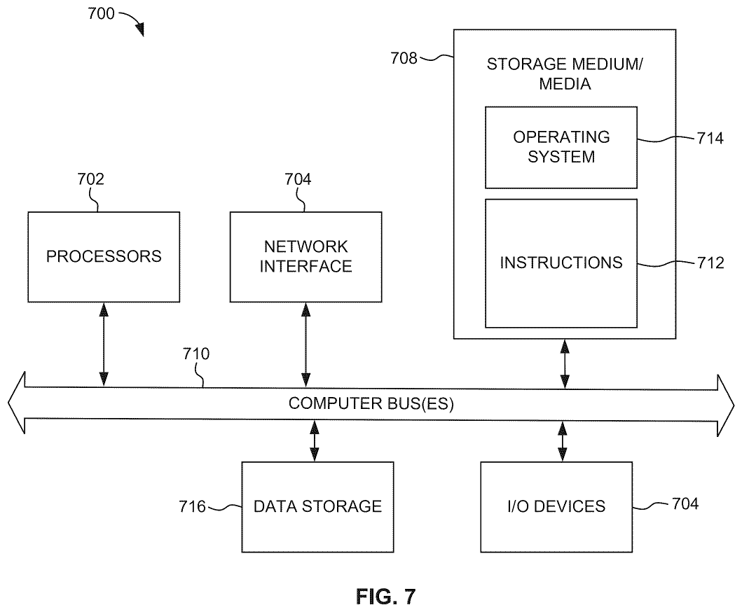

FIG. 7 depicts a computer system 700 that may be used to implement the system 102. More particularly, computing machines such as desktops, laptops, smartphones, tablets, and wearables which may be used to facilitate the electronic transaction over the computer network 112, while deriving the outcome for the electronic transaction. The computer system 700 may include additional components not shown and that some of the process components described may be removed and/or modified. In another example, a computer system 700 may be deployed on external-cloud platforms such as cloud, internal corporate cloud computing clusters, organizational computing resources, and/or the like.

The computer system 700 includes processor(s) 702, such as a central processing unit, ASIC or another type of processing circuit, input/output devices 704, such as a display, mouse keyboard, etc., a network interface 706, such as a Local Area Network (LAN), a wireless 802.11x LAN, a 3G or 4G mobile WAN or a WiMAX WAN, and a computer-readable medium 708. Each of these components may be operatively coupled to a bus 710. The computer-readable medium 708 may be any suitable medium that participates in providing instructions to the processor(s) 702 for execution. For example, the computer-readable medium 708 may be non-transitory or non-volatile medium, such as a magnetic disk or solid-state non-volatile memory or volatile medium such as RAM. The instructions or modules stored on the computer-readable medium 708 may include machine-readable instructions 712 executed by the processor(s) 702 that cause the processor(s) 702 to perform the methods and functions of the system 102.

The system 102 may be implemented as software stored on a non-transitory processor-readable medium and executed by the processor(s) 702. For example, the computer-readable medium 708 may store an operating system 714, such as MAC OS, MS WINDOWS, UNIX, or LINUX, and code, for the system 102. The operating system 714 may be multi-user, multiprocessing, multitasking, multithreading, real-time, and the like. For example, during runtime, the operating system 714 is running and the code for the system 102 is executed by the processor(s) 702.

The computer system 700 may include a data storage 716, which may include non-volatile data storage. The data storage 716 stores any data used or generated by the system 102.

The network interface 706 connects the computer system 700 to internal systems for example, via a LAN. Also, the network interface 706 may connect the computer system 700 to the Internet. For example, the computer system 700 may connect to web browsers and other external applications and systems via the network interface 706.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 702 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method for determining an outcome for an electronic transaction over a computer network, comprising:
gathering information associated with the electronic transaction, including information associated with one or more of a product, service, or entity associated with the electronic transaction;
generating a user profile for a user associated with the electronic transaction;
modifying an aspect of a virtual agent configured to facilitate the electronic transaction based on the information associated with the electronic transaction and the user profile;
communicating an initial proposition to the user via an initial proposition communication, wherein the initial proposition is based on an initial engagement strategy to facilitate the electronic transaction;
interacting, via the virtual agent, with the user to gather additional information associated with the electronic transaction and the initial proposition;
dynamically modifying the initial proposition to generate an alternative proposition, including generating an alternative engagement strategy to facilitate the electronic transaction based on the initial engagement strategy and the additional information, wherein the alternative engagement strategy is generated based on adjusting of weighting values of a strategy selection model configured to evaluate a plurality of engagement strategies;
communicating the alternative proposition to the user via an alternative proposition communication;
receiving a response to the alternative proposition from the user; and
determining the outcome for the electronic transaction based on the response to the alternative proposition.

2. The method of claim 1, further comprising:
analyzing the response to the alternative proposition from the user to generate a future proposition; and
implementing the future proposition in a future electronic transaction associated with the user or another user.

3. The method of claim 1, wherein generating the user profile includes gathering information associated with one or more previous electronic transactions, demographic information, emotional state information, constraint information, and intent information.

4. The method of claim 1, wherein the alternative engagement strategy based on consultation includes one or more alternative engagement strategies derived by prioritizing one or more of emotional state information, constraint information, and intent information associated with the user.

5. The method of claim 1, wherein the alternative engagement strategy is based on one or more of a credibility appeal, a logical appeal, and an emotional appeal.

6. The method of claim 1, wherein the additional information includes one or more of nonverbal cues, situation information, and emotional state information associated with the user.

7. The method of claim 1, wherein the alternative proposition includes one or more of targeted advice associated with the electronic transaction, a counteroffer, a discounted price, an alternative service, an alternative product, an additional service, an additional product, and a modified service, or a modified product.

8. The method of claim 1, wherein the alternative proposition includes one or more of a persuasion, a nudge, a negotiation, and advice associated with the electronic transaction.

9. The method of claim 1, wherein generating the initial proposition communication includes providing the initial engagement strategy to a large language model (LLM) to generate the initial proposition communication.

10. The method of claim 1, wherein generating the alternative proposition communication includes providing the alternative engagement strategy to a large language model (LLM) to generate the alternative proposition communication.

11. A non-transitory, computer-readable medium including machine-readable instructions that are executable by a processor to:
communicate an initial proposition to a user via an initial proposition communication, wherein the initial proposition is based on an initial engagement strategy to facilitate an electronic transaction;
interact, via a virtual agent, with the user to gather additional information associated with the electronic transaction and the initial proposition;
dynamically modify the initial proposition to generate an alternative proposition, including generating an alternative engagement strategy to facilitate the electronic transaction based on the initial engagement strategy and the additional information, wherein the alternative engagement strategy is generated based on an adjusting of weighting values of a strategy selection model configured to evaluate a plurality of engagement strategies;
communicate the alternative proposition to the user via an alternative proposition communication;
receive a response to the alternative proposition from the user; and
deriving an outcome for the electronic transaction based on the response to the alternative proposition.

12. The non-transitory, computer-readable medium of claim 11, wherein the alternative engagement strategy based on consultation includes one or more alternative engagement strategies derived by prioritizing one or more of emotional state information, constraint information, and intent information associated with the user.

13. The non-transitory, computer-readable medium of claim 12, including instructions executable by the processor to:
gather information associated with the electronic transaction, including information associated with one or more of a product, service, or entity associated with the electronic transaction;
generate a user profile for the user associated with the electronic transaction, including gathering information associated with one or more previous electronic transactions, demographic information, emotional state information, constraint information, and intent information; and
modify an aspect of the virtual agent configured to facilitate the electronic transaction based on the information associated with the electronic transaction and the user profile.

14. The non-transitory, computer-readable medium of claim 11, wherein communicating the initial proposition communication includes providing the initial engagement strategy to a large language model (LLM) to generate the initial proposition communication.

15. The non-transitory, computer-readable medium of claim 11, wherein communicating the alternative proposition communication includes providing the alternative engagement strategy to a large language model (LLM) to generate the alternative proposition communication.

16. A system comprising:
a processor;
a non-transitory memory device including machine-readable instructions that are executable by the processor to:
gather information associated with an electronic transaction, including information associated with one or more of a product, service, or entity associated with the electronic transaction;
generate a user profile for a user associated with the electronic transaction;
modify an aspect of a virtual agent configured to facilitate the electronic transaction based on the information associated with the electronic transaction and the user profile;
communicate an initial proposition to the user via an initial proposition communication, wherein the initial proposition is based on an initial engagement strategy to facilitate the electronic transaction;
interact, via the virtual agent, with the user to gather additional information associated with the electronic transaction and the initial proposition;
dynamically modify the initial proposition to generate an alternative proposition, including generating an alternative engagement strategy to facilitate the electronic transaction based on the initial engagement strategy and the additional information, wherein the alternative engagement strategy is generated based on an adjusting of weighting values of a strategy selection model configured to evaluate a plurality of engagement strategies;
communicate the alternative proposition to the user via an alternative proposition communication;
receive a response to the alternative proposition from the user; and
deriving an outcome for the electronic transaction based on the response to the alternative proposition.

17. The system of claim 16, wherein the non-transitory memory device further includes machine-readable instructions that are executable by the processor to:
analyze the response to the alternative proposition from the user to generate a future proposition; and
implement the future proposition in a future electronic transaction associated with the user or another user.

18. The system of claim 17, wherein generating the user profile includes gathering information associated with one or more previous electronic transactions, demographic information, emotional state information, constraint information, and intent information.

19. The system of claim 18, wherein the alternative engagement strategy based on consultation includes one or more alternative engagement strategies derived by prioritizing one or more of emotional state information, constraint information, and intent information associated with the user.

20. The system of claim 19, wherein the additional information includes one or more of nonverbal cues, situation information, and emotional state information associated with the user.
